(19) United States
(12) Patent Application Publication
(10) Pub. No.: US 2013/0113656 A1
(43) Pub. Date: May 9, 2013

(54) METHOD OF REDUCING THE GLARE OF A RECEIVER RECEIVING SIGNALS FROM EMITTERS

(71) Applicants: Alexandre Vervisch-Picois, Paris (FR); Nel Samama, Chennevieres (FR)

(72) Inventors: Alexandre Vervisch-Picois, Paris (FR); Nel Samama, Chennevieres (FR)

(73) Assignee: INSTITUT-TELECOM/TELECOM SUDPARIS, Evry (FR)

(21) Appl. No.: 13/807,799

(22) PCT Filed: Jul. 1, 2011
(86) PCT No.: PCT/IB2011/052916

§ 371 Date: Jan. 18, 2013

(30) Foreign Application Priority Data
Jul. 1, 2010 (FR) 1055302

(51) Int. Cl. G01S 19/21

(52) U.S. Cl. CPC G01S 19/21
USPC 342/357.59

(57) ABSTRACT

The present invention relates to a method of reducing the glare of at least one receiver within a positioning system, the system including a plurality of emitters, each emitter emitting signals modulated by one and the same code whose autocorrelation function exhibits a main peak and at least one white zone in which the autocorrelation function is a minimum, the signals for each emitter includes a first signal modulated by the code and a second signal out of phase with respect to the first signal, the second signal being modulated by the code which is delayed with respect to the code modulating the first signal, and a receiver, the latter being configured so as to detect signals emitted by the emitters and implementing, for the tracking of the first and second signal emitted by one of the emitters, a local signal modulated by the code.

The subject of the present invention is a method for reducing the glare of at least one receiver within a positioning system, as well as such a positioning system.

The invention applies more particularly to systems using code-based multiplexing, also called “code divisional multiple access” (CDMA), this being for example the case for GPS (global positioning system) and for GNSS (global navigation satellite system).

The phenomenon of glare (known as “near far”), also called the phenomenon of intrinsic interference, is a major problem occurring in systems using CDMA, the signals being emitted on the same frequency. When the codes used by the system emission sources do not exercise sufficient discrimination with respect to the difference in power which may exist between these codes on reception by a receiver of the system, this phenomenon of glare or intrinsic interference occurs. When the receiver is dazzled by glare, it is no longer capable of tracking the weakest code, even by making errors.

The codes used in the known systems may be Gold codes. The latter are for example described in the article “Optimal binary sequencies for spread spectrum multiplexing” by Robert GOLD. The Gold code is also called a “C/A” (Coarse Acquisition) or “civilian” code. Its length is 1023 moments and it is clocked at 1.023 MHz. The smallest period of the Gold codes is therefore exactly 1 ms.

A Gold code is the result of combining two time-shifted maximal length sequences. Within the meaning of the invention, the expression “maximal length sequence” designates periodic binary sequences generated by shift registers, for example of 10 bits for GPS and 9 bits for the Russian GLONASS system. The properties of maximum length sequences are as follows:
they are balanced, that is to say the number of is in the code is equal to 1+ the number of 0s in the code and,
if large N is the size of the sequence, the auto-correlation equals −1/N away from the main peak.

For the positioning of objects in a zone not covered by GPS or GNSS systems, it is known to deploy a constellation of emitters in said zone, the latter corresponding for example to the inside of a building. It is possible to recover a signal on the roof of the building with the aid of an outside antenna so as to retransmit it to the inside of the building and have this signal emitted simultaneously by each of the emitters of the local constellation. In order to prevent the signals originating from the emitters of the constellation from interfering with one another at the level of a receiver of the zone, the original signal is delayed differently on each of the antennas of the emitters of the constellation, thus corresponding to a system using shifted emissions.

Nonetheless, in such systems, the glare of the signals remains. Furthermore, the presence of indirect path in the zone, for example on account of walls of the building when the zone in which one seeks to perform the positioning is a building, disturbs the measurements of the code modulating the emitted signals.

The two problems mentioned hereinabove can render position detection by the system more complex and less precise.

There exists a need to benefit from a method for reducing the glare of at least one receiver of a system comprising several emitters emitting signals modulated by one and the same code, which is relatively simple to implement while being effective and inexpensive.

The aim of the invention is to address this need and it achieves same, according to one of its aspects, by virtue of a method for reducing the glare of at least one receiver within a positioning system, the system comprising:
a plurality of emitters, each emitter emitting signals modulated by one and the same code whose auto-correlation function exhibits a main peak and at least one white region in which said auto-correlation function is a minimum, said signals comprising for each emitter a first signal modulated by the code and a second signal phase-shifted with respect to the first signal, the second signal being modulated by the code which is delayed with respect to the code modulating the first signal,
a receiver, the latter being configured to detect the signals emitted by the emitters and implementing, for the tracking of the first and of the second signal emitted by one of the emitters, a local signal modulated by the code, in which method:
each emitter emits the first, respectively second, signal modulated by the code whose phase is different from the phases of the code modulating the first, respectively second, signal of the other emitters of the system, the main correlation peak of the first signal and that of the second signal emitted by each emitter being disposed in a white region of a calculated correlation function for the correlation between the local signal of the receiver and the signals emitted by all the other emitters of the system and,
a correlation function is calculated for the correlation between the local signal of the receiver and a signal resulting from a combination of the signals emitted by the emitters of the system, in such a way that some terms of this correlation function vanish, so as to reduce the glare of the receiver.

According to the invention, the signals emitted by the emitters of the system and the calculation of the correlation function are such that by calculating this correlation function alone, one cancels all or part of the terms of said function conveying the glare of the receiver by the signals other than the first and second signals emitted by the emitter that one seeks to track, making it possible to reduce, or indeed to eliminate, the glare of the receiver.

Furthermore, in the method described hereinabove, each emitter of the system simultaneously emits two signals and it is one of the signals emitted by this emitter which makes it possible to remove the interference caused by the other of the signals emitted by this emitter. Consequently, it will be possible for the majority of the physical phenomena undergone by one of the two signals emitted by each emitter to be the same as those undergone by the other of said two signals. This may make it possible to reduce or eliminate also the indirect paths of the interfering signal.

The code used may be a maximal sequence code. The auto-correlation function of such a code has the property of always exhibiting the same secondary peak level outside of the main correlation peak, these secondary peaks all taking the lowest value of the auto-correlation function. A maximal sequence generated on a 10-bit register has a single secondary peak level which equals −1/1023 when the main correlation peak equals 1. This secondary peak level corresponds to a ratio

$$\frac{Power\_signal \_received}{Power\_interference}$$

equal to 60.2 dB. Employing a maximal length sequence as code modulating the signals makes it possible to very appreciably reduce the value of the secondary peaks in the calculated correlation function.

As a variant, the code modulating the signals emitted by the emitters of the system is not a maximal length sequence and, for the emitters of the system, the phase shift of the code modulating the first signal, respectively the second signal, are chosen beforehand from one emitter to the next, in such a way that the main correlation peak of the first signal and that of the second signal of each emitter are in a white region of the calculated correlation function for the correlation between the local signal of the receiver and the signals emitted by all the other emitters of the system.

Such a choice of phase shift of the code of the first signal, respectively of the second signal, from one emitter to the next makes it possible to displace in the calculated correlation function the auto-correlation peaks of the signals emitted by each emitter of the system in such a way that no secondary peak of too significant value of said correlation function can interfere with a main correlation peak, thereby making it possible to obtain in terms of reduction in interference performance equivalent to that of a system in which a maximal length sequence code is used.

When a code other than a maximal length sequence is used, for example a Gold code, the phase shifts may be determined as a function of each code since the number and the site of the white regions differs from one code to the next. The white regions may be determined by an algorithm, described for example in the publication VERVISCH-PICOIS A., SAMAMA N., “Interference Mitigation in a Repeater and Pseudolite Indoor Positioning System” IEEE Journal of Selected Topics in Signal Processing, vol 3 issue 5, pp 810-820, October 2009.

The phase shift of the code modulating the first, respectively second, signal from one emitter to the next, satisfies for example the following relation φₖ₊₁−φₖ>2 chips+d_{Indoor}, “d_{Indoor}” designating the largest distance encountered in the positioning environment, including the potential indirect paths and a “chip” corresponding to a code moment or a code bit. Such a phase shift value can make it possible to reduce the glare when the code used to modulate the signals is a maximal length sequence.

The code phase shift between the code modulating the first signal emitted by one emitter and the code modulating the first signal emitted by another emitter may be equal to the code phase shift between the code modulating the second signal emitted by said emitter and the code modulating the second signal emitted by this other emitter. As a variant, between two emitters, the first and second signals are phase-shifted by a different value.

The delay of the code modulating the second signal with respect to the code modulating the first signal may be the same or, as a variant, be different for at least two emitters of the system.

The phase shift between the first and the second signal emitted by each emitter may be equal to 180°, to within 10%, thereby allowing a further reduction in the glare of the receiver.

The method may be implemented inside (indoors), serving for example for the positioning of objects in zones not covered by GPS or GNSS, for example buildings.

The receiver can perform an anti-aliasing filtering of the signals emitted by the emitters, especially with the aid of a filter of bandwidth less than or equal to 10 MHz, especially less than or equal to 8 MHz, especially less than or equal to 6 MHz, especially less than or equal to 4 MHz, especially less than or equal to 2 MHz, thereby making it possible to reduce the noise related to the spectral aliasing, the latter having a direct impact on the value taken by the correlation function.

When the signal used is the civilian GPS signal of frequency L1, 90% of its energy is distributed over only 2 MHz. Thus, employing a low-pass or bandpass filter having a passband of 2 MHz may make it possible, with a sampling frequency of between 4 and 5 MHz, to satisfactorily limit the consequences of the aliasing, while working with relatively low sampling frequencies that do not consume too much energy.

As a variant, or in combination with an anti-aliasing filtering step, the method according to the invention can comprise a step of sampling by the receiver of the signals emitted by the emitters according to a sampling frequency such that the ratio between said sampling frequency and the width of the base spectrum of said emitted signals is greater than or equal to 5, especially greater than or equal to 10, especially greater than or equal to 20, especially greater than or equal to 30, especially greater than or equal to 40, especially greater than or equal to 50. The use of a high sampling frequency can allow for the aliased part of the spectrum to have as little energy as possible, thus reducing the overlap noise. In the case of the civilian GPS signal of frequency L1, this spectrum width is 2 MHz and the sampling frequency can be between 5 MHz and 50 MHz, or indeed up to 100 MHz. As a variant, the signal used may be a military GPS signal whose spectrum has a width of 20 MHz, the sampling frequencies then being 50, or indeed 100 MHz.

Independently or in combination with the anti-aliasing filtering and oversampling steps, the method can comprise a step according to which the receiver decreases the frequency of the code modulating the signals emitted by the emitters by a ratio of greater than 20, especially lying between 20 and 600, especially lying between 50 and 600, especially 100 and 600, especially between 100 and 150. By reducing the frequency of the code, the energy of the signal is concentrated over a narrower band. It is thus possible to obtain a spectrally denser signal that is less prone to the interference of the spectral aliasing for the same sampling frequency.

The receiver may be static, that is to say all the relative Dopplers between the signals originating from the emitters of the system in the signal received by the receiver are zero.

As a variant, the receiver may not be static.

The subject of the invention is further, according to another of its aspects, a method for reducing the glare of at least one receiver within a positioning system, the system comprising:
a plurality of emitters, each emitter emitting signals modulated by one and the same maximal length sequence code, said signals comprising for each emitter a first signal modulated by the code and a second signal phase-shifted with respect to the first signal, the second signal being modulated by the code which is delayed with respect to the code modulating the first signal,
a receiver, the latter being configured to detect the signals emitted by the emitters and implementing, for the tracking of the first and of the second signal emitted by one of the emitters, a local signal modulated by the code,
   in which method:
each emitter emits the first and the second signal and,
a correlation function is calculated for the correlation between the local signal of the receiver and a signal resulting from a combination of the signals emitted by the emitters of the system, in such a way that some terms of this correlation function vanish so as to reduce the glare of the receiver.

The subject of the invention is further, according to another of its aspects, a positioning system, comprising:
a plurality of emitters, each emitter emitting signals modulated by one and the same code whose auto-correlation function exhibits a main peak and at least one white region in which said auto-correlation function is a minimum, said signals comprising for each emitter a first signal modulated by the code and a second signal phase-shifted with respect to the first signal, the first, respectively second, signal being modulated by the code which is delayed with respect to the code modulating the first, respectively second, signal of the other emitters of the system, the main correlation peak of the first signal and that of the second signal emitted by each emitter being disposed in a white region of a calculated correlation function for the correlation between the local signal of the receiver and the signals emitted by all the other emitters of the system,

and
a receiver configured to receive the signals emitted by the emitters and implementing, for the tracking of the first and of the second signal emitted by one of the emitters, a local signal modulated by the code, the receiver being configured to calculate a correlation function for the correlation between the local signal of the receiver and a signal resulting from a combination of the signals emitted by the emitters of the system.

The subject of the invention is further, according to another of its aspects, an emitter intended to be used within a positioning system, said system comprising at least one other emitter and a receiver configured to detect the signals emitted by said emitter and the other emitter, said emitter being configured to emit a first signal modulated by a code common to the other emitter of the system and a second signal phase-shifted with respect to the first signal, the second signal being modulated by the code which is delayed with respect to the code modulating the first signal.

The common code modulating the signals emitted by the emitters may be a maximal length sequence code.

The subject of the invention is further, according to another of its aspects, a receiver intended to be used within a positioning system comprising a plurality of emitters each emitting signals modulated by one and the same code whose auto-correlation function exhibits a main peak and at least one white region in which said auto-correlation function is a minimum, said signals comprising for each emitter a first signal modulated by the code and a second signal phase-shifted with respect to the first signal, the second signal being modulated by the code which is delayed with respect to the code modulating the first signal,

the receiver being configured to receive the signals emitted by the emitters and implementing, for the tracking of the first and of the second signal emitted by one of the emitters, a local signal modulated by the code, and to calculate a correlation function for the correlation between the local signal of the receiver and a signal resulting from a combination of the signals emitted by the emitters of the system.

The invention may be better understood on reading the description which follows of nonlimiting examples of implementation of the latter and on examining the appended drawing in which:

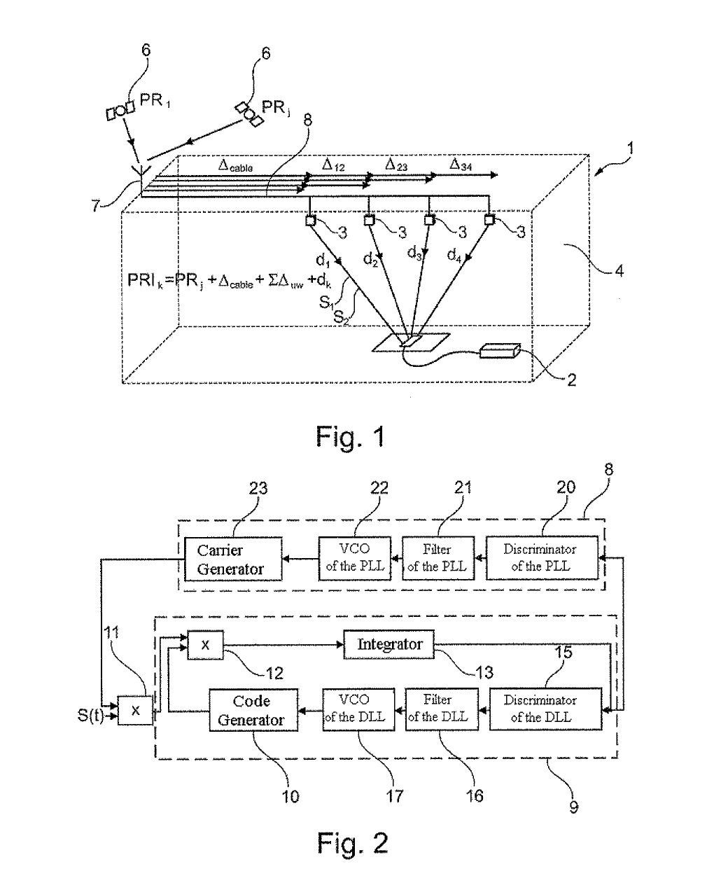

FIG. 1 represents in a schematic manner a system in which a method according to the invention may be implemented,

FIG. 2 functionally represents the generator of the local signal of the receiver,

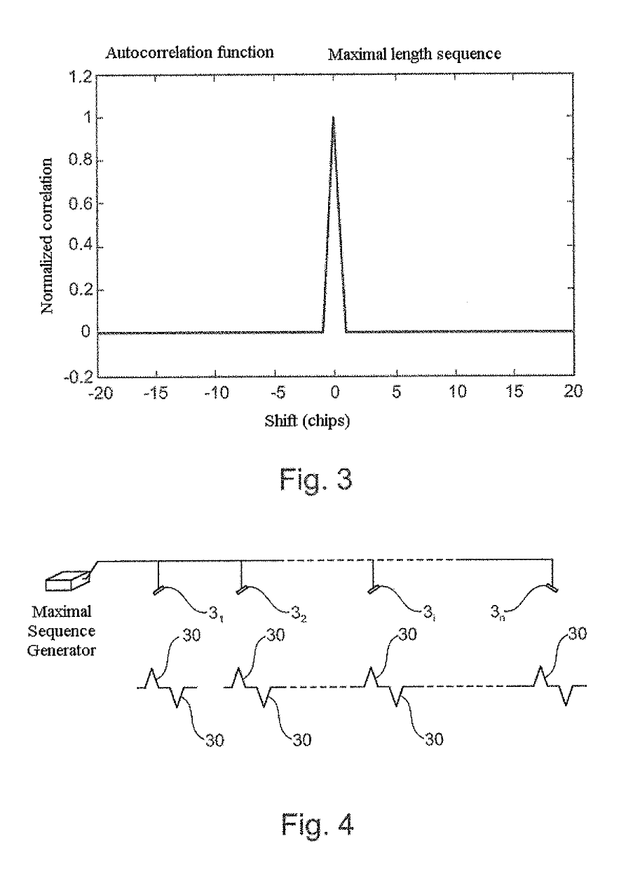

FIG. 3 is a representation of the auto-correlation function of a maximal length sequence code,

FIG. 4 represents in a schematic manner the calculated correlation function for the correlation between the signals emitted by the emitters of the system and the local signal of the receiver,

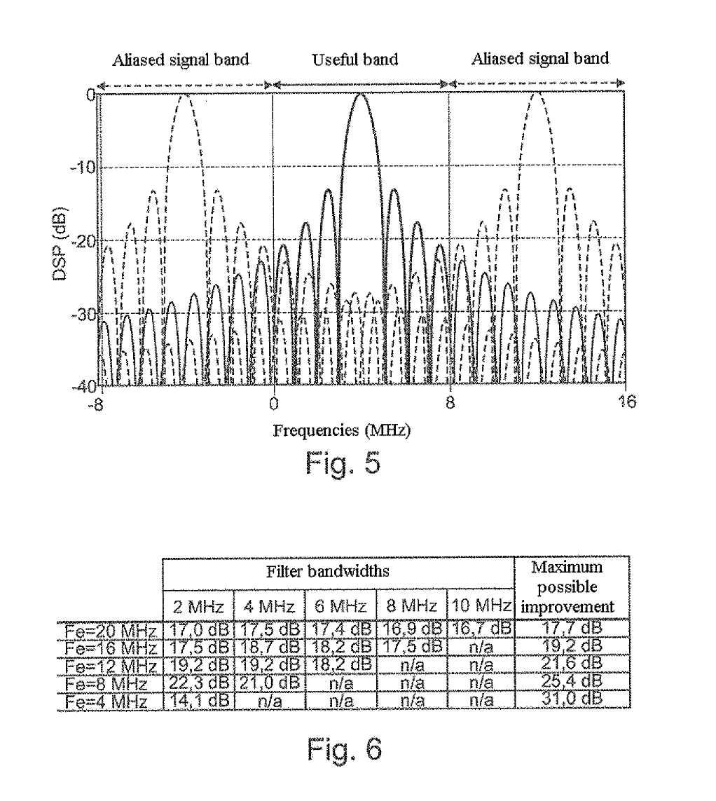

FIG. 5 is a spectral representation of the envelope of a GPS signal on L1 after sampling at 16 MHz,

FIG. 6 is a table showing bandwidth of the filter implemented by the receiver against reduction in the aliasing of the sampled signal,

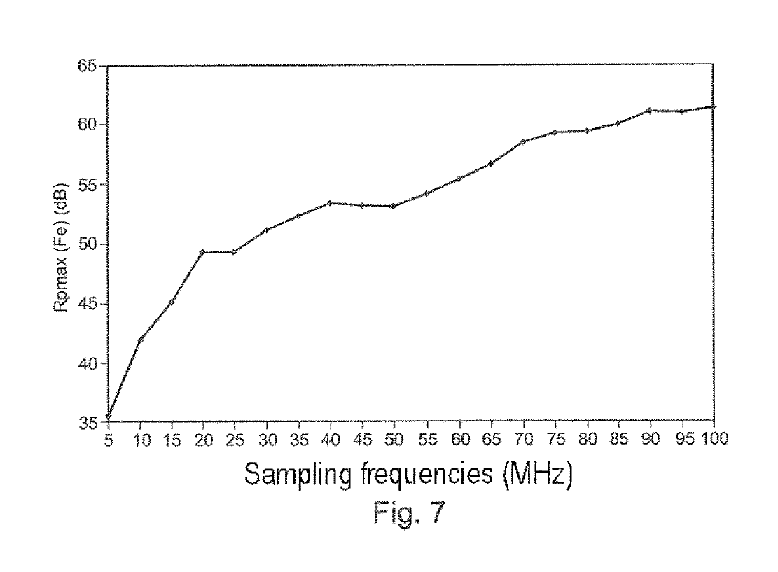

FIG. 7 represents the variation of the maximum power deviation tolerated between interfering signal and interfered signal as a function of the sampling frequency,

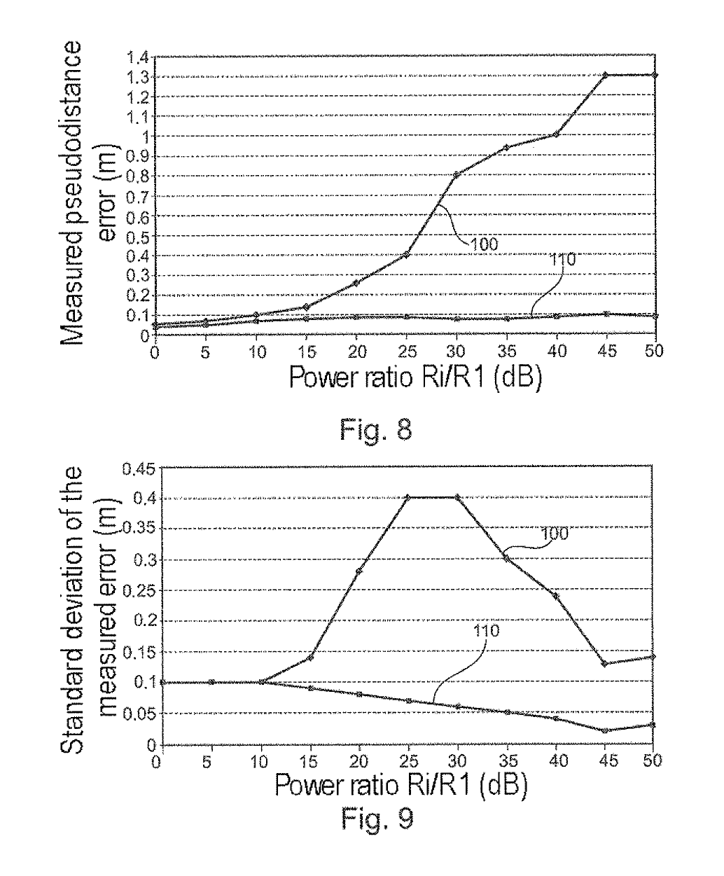

FIGS. 8 to 11 represent simulation results produced according to the invention and according to the prior art and,

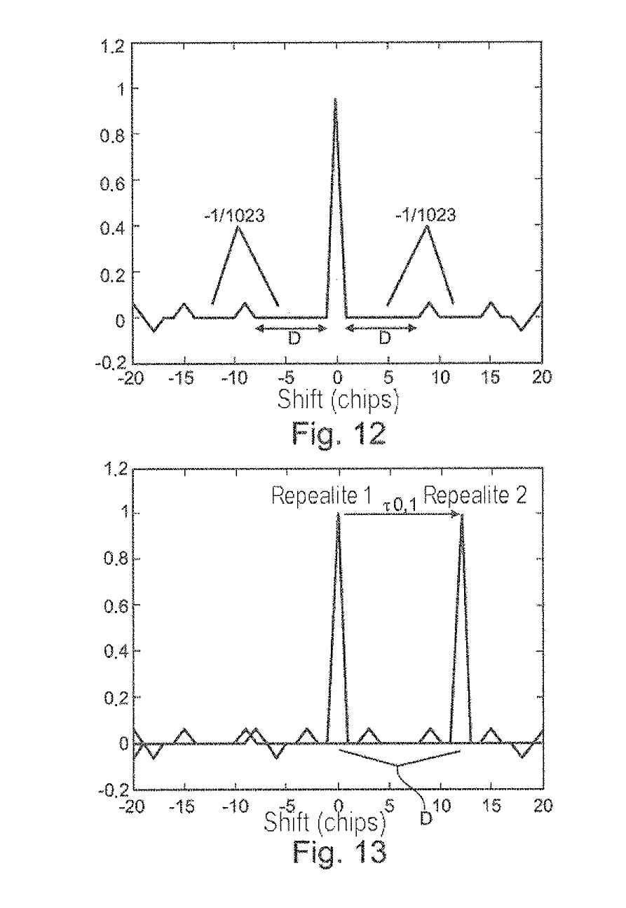

FIG. 12 represents the auto-correlation function of a code used according to another exemplary implementation of the invention and,

FIG. 13 schematically represents a step of executing an algorithm for determining the maximum number of repealites that can be deployed for a given code.

An exemplary system 1 in which the invention may be implemented has been represented in FIG. 1.

The system comprises a receiver 2 and a plurality of emitters 3 forming a local constellation. As represented in FIG. 1, the system 1 may be implemented inside (indoors), for example inside a building 4. In the exemplary application which will be described, the space situated inside the building 4 is not covered by a GPS or GNSS network, on account of the presence of the walls of the building 4.

This GPS or GNSS network comprises satellites 6 whose signals are recovered by an antenna 7 placed outside the building 3, in a zone covered by the network. These recovered signals are then dispatched via cables 8 to the emitters 3 of the system 1.

The emitters 3 are, in the example considered, repealites. The expression “repealites” designates emitters all receiving one and the same signal from an antenna, this signal being retransmitted permanently to the emitters of the constellation and emitted simultaneously by these emitters. In order to reduce the interference between these signals, the signal may be delayed differently from one emitter to the next.

In FIG. 1, the PR; designate the pseudodistances separating the satellites 6 from the outside antenna 7. These pseudodistances PRⱼ include the clock bias of the receiver 2, Δ_{cable} represents the common delay corresponding to the passage through the cables 8 and A_{i,i+1} corresponds to the intentionally induced delay between two successive emitters 3 of the constellation of emitters. Still in FIG. 1, the distances dᵢ are the distances separating the antennas of the emitters 3 from that of the receiver 2.

In the example considered, the signals emitted by the emitters 3 are modulated by a maximal length sequence code. Maximal length sequences are periodic binary sequences generated by shift registers (of 10 bits for GPS and 9 bits for the Russian GLONASS system).

The auto-correlation function of a maximal length sequence code has been represented in FIG. 3. As may be seen in this figure, this auto-correlation function always exhibits the same secondary peak level outside of the main correlation peak. For example, with a maximal sequence generated on a 10-bit register, the auto-correlation function of this sequence has a main correlation peak equal to 1 and a single secondary peak level which equals −1/1023. This secondary peak level corresponds to a ratio

$$\frac{Power\_signal \_received}{Power\_interference}$$

equal to 60.2 dB.

In the case of a maximal sequence code, the expression “white region” subsequently designates the secondary peaks of the auto-correlation function of a maximal length sequence code.

The invention is, however, not limited to the employment of maximal length sequences to modulate the signals emitted by the emitters 3, as will be seen subsequently.

The signals emitted by the emitters are for example GPS signals of frequency L1. These signals are received by the antenna of the receiver 2 and then amplified and converted into intermediate frequency (FI), below the frequency f_{L1}.

In the example considered, these signals are sampled and then digitized before being processed by the reception channels of the receiver 2. These reception channels implement tracking loops represented in FIG. 2.

These loops comprise two phase-locked loops, the PLL loop 8 and the DLL loop 9, serving to demodulate respectively the carrier and the code of the signal of the first emitter 3.

For the tracking of the first signal, the receiver uses a local replica of the signal decomposed into two distinct elements: carrier and code, which the loops 8 and 9 synchronize permanently with the signal emitted by the first emitter. As many emitters as there are channels in the receiver can be tracked in parallel.

FIG. 2 shows the tracking loops 8 and 9, embedded one in the other and using the same correlators (or integrators).

The local signal in a channel of the receiver 2 may be modeled in a grouped form as follows:

S_{loc,j}(t,τ)=sin(2π·(FI+f_{loc})·t+θ_{loc})·c(t−τ)

f_{loc} corresponds to the Doppler frequency of the local signal on the carrier and θ_{loc} corresponds to the phase on this carrier, including the clock bias and drift of the receiver 2, τ is the delay induced on the code i being tracked.

The DLL loop 9 will firstly be described. The objective of the latter is to synchronize the local code of the receiver on the incident code. This loop is for example the so-called “Early minus Late” (or “Advance minus Delay”) loop that is sometimes also called SDLL for Standard DLL.

This loop comprises a code generator 10 configured to create three replicas of the code: a replica in advance by 0.5 chips (a chip designating here a code moment or code bit) called E (Early), a replica delayed by 0.5 chips called L (Late) and a replica with no phase offset called P (Prompt). These replicas make it possible to ensure the operation of the discriminator 15, which will be described hereinafter, of the loop 9 and are generated on the basis of the control signal of the VCO 17, which will also be described subsequently.

The incident signal S corresponding to the sum of the signals emitted by the emitters is mixed by a mixer 11 with the local replicas of the carrier and then with the three replicas of the local code which arise from the code generator 10 by a mixer 11

The resulting signal is summed by the integrator 13 over a time Ts which is the integration time of the loops. This operation has two objectives: it plays both the role of low-pass filter and of correlator.

The low-pass filtering makes it possible to eliminate the high-frequency part at f_{loc}+FI.

In the integrator 13, six correlation operations are performed, these being designated as follows:
IP corresponds to the in-phase Prompt correlation
IE corresponds to the in-phase Early correlation
IL corresponds to the in-phase Late correlation
QP corresponds to the quadrature Prompt correlation
QE corresponds to the quadrature Early correlation and,
QL corresponds to the quadrature Late correlation

The results at the output of the integrator 13 are thereafter dispatched to the discriminator 15.

The discriminator 15 of the loop 9 is configured to detect the phase error between the code c of the signal that one seeks to track and the local code. Its formula in a normalized version is for example but nonlimitingly

$$D = \frac{\sqrt{{IE}^{2} + {QE}^{2}} - \sqrt{{IL}^{2} + {QL}^{2}}}{\sqrt{{IE}^{2} + {QE}^{2}} + \sqrt{{IL}^{2} + {QL}^{2}}}$$

The discriminator 15 is balanced when the early correlation is equal to the late correlation.

The output of the discriminator is linear for an error lying between 0.5 and −0.5 chips, being able to operate up to ±1.5 chips without diverging.

The discriminator 15 makes it possible to obtain the corresponding phase shift between the code of the signal that it is sought to track and the code of the local signal, thereby allowing the loop 9 to correct by the necessary quantity the phase of the local code that it generates.

The signal at the output of the discriminator 15 is thereafter processed by a filter 16 configured to reduce the noise in the loop 9. This filter 16 can also make it possible to eliminate the residual spurious signals caused either by outside interference, or by cross-correlation with the other signals.

The filter 16 is for example an active low-pass filter affording gain in the passband. It is possible to act on the following parameters, according to the objective sought:
the order of the filter and,
the equivalent noise band Bn.

The expression “order of the filter” should be understood to mean the number of reactive elements, such as inductors and capacitors, which make up the electronic equivalent of the digital filter.

A high filter order can confer better resilience in the dynamic regime, the loop 9 then being capable of following the accelerations, but being more sensitive to noise and above all more unstable.

As regards the equivalent noise band, the higher is Bn, the more it is possible to tolerate frequency excursions in the loop and the greater the possibility of catering for significant dynamic loadings. On the other hand, the noise may be higher. The loop 9 being very noisy but relatively static (the variations in the Doppler on the code are very low from one integration to the next), the value of Bn chosen is in general fairly low. A typical value of Bn is 0.5 Hz for the loop 9. In other examples, Bn may be as small as 0.05 Hz

When the loop 9 is balanced, the output of the filter 16 corresponds to the Doppler difference between the code modulating the signals emitted by the emitters 3 and the local code of the receiver 2. The output of the filter 16 is then received at the input of the VCO (voltage controlled oscillator) 17.

The VCO 17 performs an operation of integrating the signal at the output of the filter 16 to obtain a phase, a clock signal then being generated on the basis of this phase and of the central frequency of the VCO, which equals for example 1.023 MHz, this clock signal thereafter driving the code generator 10.

The operation of the PLL loop 8 will now be described. This loop 8 is configured to demodulate the carrier of the incident signal. It entails for example a Costas loop.

This loop 8 comprises a discriminator 20 whose standardized formula is for example but nonlimitingly

$$D = arctan ( \frac{QP}{IP} )$$

with QP and IP such as already defined above.

The signal at the output of the discriminator 20 is thereafter processed by a filter 21 which is of the same type as the filter 16 described previously. The order of the filter 21 is for example equal to n+1, when n is the order of the filter 16, and the value of Bn of the filter 21 is greater than that of the filter 16, lying for example between 10 Hz and 18 Hz.

The signal at the output of the filter 21 is thereafter processed by a VCO 22 specific to the loop 8, this VCO 22 operating in the same manner as the VCO 17 described previously.

The signal at the output of the VCO 22 thereafter drives a carrier generator 23.

In the example of FIG. 4, the VCO 17 of the loop 9 receives as input only the signal at the output of the filter 16.

In a variant, not represented, the signal at the output of the filter 21 is also transmitted to the VCO 17 of the loop 9, the VCO 17 then generating a clock signal with the aid of the output of the filter 16 of the loop 9 and of the filter 21 of the loop 8. The signal at the output of the filter 16 is divided by the ratio between the frequency f_{L1} and the frequency of the code, that is to say by 1540 in the example described. Such a recovery of the signal at the output of the filter 21 can especially make it possible to use values as small as 0.05 Hz for the equivalent noise band Bn of the filter 16 of the loop 9.

According to the example described, each emitter 3 emits a pair of signals S1 and S2 phase-shifted by a certain code fraction. The two signals S1 and S2 are also, in the example considered, phase-shifted by 180°.

The phase shift between the two code fractions may be arbitrary, for example equal to or different from the half-period of this code.

The expression for the signal received by the receiver 2 on account of the emission by each emitter 3 of the system of a pair of signals S1 and S2 is equation (5.1):

$$S ( t ) = {\sum }_{k = 1}^{{n}_{t}} {A}_{k} \cdot {D}_{k} ( t ) \cdot sin ( 2 π \cdot ( {f}_{L 1} + {f}_{k} ) \cdot t + {θ}_{k} ) \cdot [ {c}_{SM} ( t - {φ}_{k} - {d}_{k} ) - {c}_{SM} ( t - {φ}_{k} - ϕ - {d}_{k} ) ] + n ( t )$$

nᵣ being the number of repealites 3 of the local constellation of the system 1, Aₖ being the amplitude of the signal emitted by the repealite 3ₖ, Dₖ being the navigation message associated with the repealite 3ₖ, fₖ being the Doppler frequency associated with the repealite 3ₖ at the level of the antenna of the receiver 2, including the drift of the clock bias of the receiver, θₖ being the phase of the carrier associated with the repealite 3ₖ, c_{SM} being the maximal length sequence emitted by the repealites, φₖ being the phase shift induced on the code to distinguish between the emissions of the repealites 3ₖ, φ being the phase shift between the codes modulating the first and second signals emitted by the same antenna, dₖ being the pseudodistance between the antenna of the receiver 2 and that of the repealite 3ₖ, n(t) being the thermal noise and other sources of error.

In the example considered the code phase shift φₖ₊₁−φₖ between the first signal of the repealite 3ₖ and the first signal of the repealite 3ₖ₊₁ is equal to the code phase shift between the second signals of these repealites. These phase shift values φₖ₊₁−φₖ may be chosen so as to take predetermined values.

For example φₖ₊₁−φₖ is chosen greater than 2 chips+d_{Indoor}. The distance d_{Indoor} is for example determined as a function of the size of the environment, dIndoor being the largest distance encountered in the environment between the emitter and the receiver.

d_{Indoor} is for example determined by reading from a plan of the building or by measurement with a laser telemeter, with if appropriate a wider or narrower margin.

As mentioned previously, the code phase shift φ between the two signals S1 and S2 emitted by one and the same repealite 3ₖ can take an arbitrary value, possibly equal to a half-period of the code modulating said signals. This phase shift φ may be the same for all the pairs of signals emitted by each repealite.

As a variant, this phase shift φ may differ between at least two repealites of the system 1.

The values of code phase shift φ between two signals S1 and S2 emitted by one and the same repealite 3ₖ and the values of code phase shift φₖ₊₁−φₖ from one repealite to the next may be related.

For example φ=φₖ₊₁−φₖ is chosen for each repealite 3ₖ. Such a value for φ makes it possible to contrive matters so that when calculating the auto-correlation function of the signal S(t), the auto-correlation peaks of each signal emitted by each repealite 3 of the system do not overlap, whether they originate from the same antenna or different antennas.

The local signal S_{loc}(t,τ), also called the local replica of the signal, used by the receiver is defined by expression (5.2):

S_{loc}(t,τ)=sin(2π·(FI+f_{loc})·t+θ_{loc})·c_{SM}(t−τ) (5.2)

f_{loc} being the Doppler frequency of the local signal, θ_{loc} the phase of the carrier of this local signal and τ the phase shift control of the local replica of the maximal sequence.

The determination of the repealite 3 tracked by the receiver 2 stems from the choice of the interval over which τ is displaced in expression (5.2).

During the implementation of the method according to the invention, the signal S(t) according to (5.1) is correlated with the local signal according to (5.2).

To calculate the correlation function, the integration time is chosen for example equal to T, T being equal to an integer number of periods of the maximal length sequence code.

The correlation function can then be written as a sum of nᵣ terms Rₖ(τ) defined according to expression (5.3):

$${R}_{k} ( τ ) = \frac{{A}_{k}}{T} {\int }_{t = 0}^{t = T} cos ( 2 π ( {f}_{k} - {f}_{loc} ) \cdot t + {θ}_{k} - {θ}_{loc} ) \cdot {c}_{SM} ( t - {φ}_{k} - {d}_{k} ) \cdot {c}_{SM} ( t - τ ) \cdot d t \\ - \frac{{A}_{k}}{T} {\int }_{t = 0}^{t = T} cos ( 2 π ( {f}_{k} - {f}_{loc} ) \cdot t + {θ}_{k} - {θ}_{loc} ) \cdot {c}_{SM} ( t - {φ}_{k} - ϕ - {d}_{k} ) \cdot {c}_{SM} ( t - τ ) \cdot d t \qquad ( 5.3 )$$

When the receiver 2 is tracking the signal of the repealite 3ᵢ, it is possible to write: f_{loc}≈fᵢ and θ_{loc}≈θᵢ.

The expression “receiver in acquisition” should be understood to mean the phase during which the receiver determines “coarsely” the signals present, their phase shifts and their Doppler.

The expression “receiver in tracking” should be understood to mean the phase posterior to acquisition corresponding to the slaving of the phases of the local replicas of the signals found by the acquisition. The tracking phase can make it possible to obtain continuously the measurement of the propagation time by measuring the evolutions over time of the phase shift between the incident signal and its local replica generated by the receiver.

Under the assumption whereby the receiver is static, then fᵢ=fₖ for any repealite 3ₖ of the constellation.

Under these conditions, expression (5.3) may be rewritten as (5.4) hereinbelow:

$${R}_{k} ( τ ) = \frac{{A}_{k}}{T} cos ( {θ}_{k} - {θ}_{loc} ) [ {\int }_{t = 0}^{t = T} {c}_{SM} ( t - {φ}_{k} - {d}_{k} ) \cdot {c}_{SM} ( t - τ ) \cdot d t - {\int }_{t = 0}^{t = T} {c}_{SM} ( t - {φ}_{k} - ϕ - {d}_{k} ) \cdot {c}_{SM} ( t - τ ) \cdot d t ]$$

i.e. the triangle function R(τ), for example defined in the publication KAPLAN Elliot & HEGARTY Christopher, “Understanding GPS Principles and Applications”, Artech House, 2006, 2^{nd} Ed. Chapter 4, 730 p., this function being such that:

$$R ( τ ) = ( 1 - \frac{\vert τ \vert}{{T}_{c}} ) For τ ∈ [ - {T}_{c} ; + {T}_{c} ] \qquad ( 5.5 )$$

R(τ)=0 Everywhere otherwise
T_{c} is the duration of a code chip.

If N is equal to the number of chips in a code, then the auto-correlation function of a maximal sequence over the interval] 0; T [ is equal to

$$- \frac{1}{N} + \frac{N + 1}{N} R ( τ - T / 2 )$$

Under these conditions, expression (5.4) can be rewritten according to (5.7):

$${R}_{k} ( τ ) = {A}_{k} \frac{N + 1}{N} cos ( {θ}_{k} - {θ}_{loc} ) [ \begin{matrix}R ( τ - {φ}_{k} - {d}_{k} - T / 2 ) - \\ R ( τ - {φ}_{k} - ϕ - {d}_{k} - T / 2 )\end{matrix} ] \qquad ( 5.7 )$$

In the present case, because the receiver 2 is in “tracking” mode, τ belongs to one of the following two intervals:

[−T_{c}+T/2φᵢ+dᵢ;T_{c}+T/2+φᵢ+dᵢ]∪[−T_{c}+T/2+φᵢ+φ+dᵢ;T_{c}+T/2+φᵢ+φ+dᵢ]

On these intervals, Rₖ(τ) vanishes for all k≠i. Indeed, the intervals on which (5.7) is not zero are for k≠i:

[−T_{c}+T/2φₖ+dₖ;T_{c}+T/2+φₖ+dₖ]∪[−T_{c}+T/2+φₖ+φ+dₖ;T_{c}+T/2+φₖ+φ+dₖ]

Now, in the example considered, these intervals are all disjoint, since we have chosen

φ=φⱼ₊₁−φ>2 Tc+d_{Indoor}, from which it follows that
φ=φⱼ₊₁−φⱼ>2 Tc+dⱼ for all j≦nᵣ

It may therefore be concluded therefrom that expression (5.7) is zero for all k≠i. If it is desired to write the complete correlation, it suffices to write expression (5.7) for k=i.

If the receiver 2 tracks the first signal S1 emitted by the repealite 3ₖ considered, the second term R(τ−φₖ−dₖ−T/2) of expression (5.7) is zero since we are in the interval [−T_{c}+T/2+φₖ+dₖ; T_{c}+T/2+φₖ+dₖ] and the term cos(θₖ−θ_{loc}) equals 1.

If the receiver 2 tracks the second signal S2 emitted by repealite 3ₖ considered, that is to say the one whose code is phase-shifted by φ, the first term R(τ−φₖ−dₖ−T/2) of expression (5.7) is zero while the term cos(θₖ−_{loc}) equals 1.

The expression (5.7) then takes as value, depending on whether we are tracking the first or the second signal emitted by the repealite 3ₖ considered

$${R}_{i} ( τ ) = \pm {A}_{i} \frac{N + 1}{N} R ( τ - {φ}_{i} - {d}_{i} - T / 2 ) + n ( τ ) \qquad ( 5.8 )$$

Thus, by choosing integration intervals such that when tracking the pair of signals S1 and S2 emitted by a repealite 3ₖ, all the terms of the calculated correlation function for the correlation between the signals emitted by the repealites and the local signal of the receiver 2 and conveying the glare phenomena vanish, thus leaving only the main correlation peak 30 of the first or of the second signal emitted by the repealite being tracked, as may be seen in FIG. 4.

The peaks 30 of FIG. 4 represent the main correlation peaks of the diverse repealites 3. Each of them is free of the inter-correlation with the other repealites 3, although the pairs of signals emitted by each repealite 3 are all present in the signal received by the receiver and all possess the same auto-correlation function.

The only interference present on the main peak 30 of a signal S1 is the secondary level of the signal S2 emitted on the same antenna and which equals −1/1023 for a maximal length sequence generated on 10 bits.

The choice of the integration intervals may result from the values chosen for the code phase shifts between the first, respectively second, signals from one emitter to the next and of the code phase shift within a pair of first and second signals emitted by one and the same emitter.

An exemplary implementation of the invention in which the receiver 2 is static and works in acquisition will now be considered.

In this example, the emitters 3 are repealites and the signals to be acquired are distributed over a single code. The acquisition of the whole set of signals may be performed according to a single time/frequency scan.

In acquisition, τ and f_{loc} are made to vary when calculating the correlation function for the correlation between the signal S(t) according to expression (5.1) received by the receiver 2 and the local signal according to expression (5.2), so as to scan a maximum of frequencies and the entire code.

In this example, it is considered that the receiver 2 is static. Thus, it is possible to make the approximation f=fₖ for all k≦nᵣ.

Under these conditions, the calculated correlation function may be written as the sum of terms according to (5.9):

$${R}_{k} ( τ ) = \frac{{A}_{k}}{T} {\int }_{t = 0}^{t = T} cos ( 2 π ( f - {f}_{loc} ) \cdot t + {θ}_{k} - {θ}_{loc} ) \cdot {c}_{SM} ( t - {φ}_{k} - {d}_{k} ) \cdot {c}_{SM} ( t - τ ) \cdot d t \\ - \frac{{A}_{k}}{T} {\int }_{t = 0}^{t = T} cos ( 2 π ( f - {f}_{loc} ) \cdot t + {θ}_{k} - {θ}_{loc} ) \cdot {c}_{SM} ( t - {φ}_{k} - ϕ - {d}_{k} ) \cdot {c}_{SM} ( t - τ ) \cdot d t \qquad ( 5.9 )$$

Expression (5.9) can be reduced to expression (5.10), as explained in the work VAN DIERENDONCK A. J., “Global Positioning System: Theory & Applications”, Progress in Astronautics and aeronautics, 1996, Chapter 8, Vol 1, 777 p.

$${R}_{k} ( τ ) = {A}_{k} cos ( {θ}_{k} - {θ}_{loc} ) \frac{sin ( π ( f - {f}_{loc} ) T )}{π ( f - {f}_{loc} ) T} {\int }_{t = 0}^{t = T} {c}_{SM} ( t - {φ}_{k} - {d}_{k} ) \cdot {c}_{SM} ( t - τ ) \cdot d t \\ - {A}_{k} cos ( {θ}_{k} - {θ}_{loc} ) \frac{sin ( π ( f - {f}_{loc} ) T )}{π ( f - {f}_{loc} ) T} {\int }_{t = 0}^{t = T} {c}_{SM} ( t - {φ}_{k} - ϕ - {d}_{k} ) \cdot {c}_{SM} ( t - τ ) \cdot d t \qquad ( 5.10 )$$

As mentioned in the example hereinabove in which the receiver 2 operates in tracking, the terms of expression (5.10) can be grouped together and they then eliminate one another by grouping since the integrals always equal −1/1023 for a code generated on 10 bits.

The theoretical acquisition pattern, which corresponds to a three-dimensional pattern where the value of the correlation is given as a function of the phase shift of the code and of the Doppler difference between the carriers, resembles in the example considered a succession of cardinal sines spaced apart by φ=φₖ₊₁−φₖ along the code shift axis, which corresponds to time.

Concerning the indirect paths, if the calculation of the limit d_{Indoor} comprises the possible maximum distance of these paths, the indirect paths whose Doppler is identical to that of the direct signal are eliminated.

Although all the equations (5.1) to (5.8) use analog signals, the overwhelming majority of the receivers 2 used today are digital, thus involving a step of sampling the analog signals. Now, this sampling may have consequences on the effectiveness of the method for reducing the glare described hereinabove.

The Nyquist-Shannon sampling theorem, recalled for example in the publication KAPLAN Elliot & HEGARTY Christopher, “Understanding GPS Principles and Applications”, Artech House, 2006, 2nd Ed. Chapter 6, 730 p, states that in order for a signal to be sampled without loss of information, the sampling frequency must be at least twice the largest frequency contained in this signal. Formulated otherwise, this theorem states that the sampling frequency must be equal to twice the largest frequency of the spectrum of the signal so that the latter does not fold back on itself (is not aliased) after the sampling operation. The spectral aliasing induces noise having a direct impact on the value taken by the correlation function.

In the case of GPS signals, the code used to modulate the signals is of unlimited width, that is to say there does not exist any finite band which can contain it and it is not possible to sample these signals without loss of information. Indeed, as the spectrum of the code of GPS signals is unlimited in band, whatever the sampling frequency, there is always a part of this spectrum which is aliased in the direct-sampling spectral band (therefore the useful band in the sense of the largest band on which the overlap is minimal) which equals half the sampling frequency.

The codes used in GPS systems, for example Gold codes, are such that 90% of the energy lies in the 2.046 MHz of width of the main lobe of the spectrum of this code. When the receiver 2 samples at a sampling frequency of 4 to 5 MHz and with an intermediate frequency of between 1 and 1.25 MHz, the main lobe is enabled not to fold back on itself. Nonetheless, the side lobes fold back on the main lobe, giving rise to interference. The power spectral density of such a sampled GPS signal code has been represented in FIG. 5.

As may be seen in this FIG. 5, on the frequency band lying between 0 and 8 MHz, in which the sampling is direct, a part of the sidelobes, which are represented dashed, is aliased.

This aliasing effect is due to the creation of “replicas” of the signal on the frequency bands outside the useful band, the width of these bands being equal to half the sampling frequency.

As these “replicas” are formed symmetrically with the useful signal both on the right and on the left of the useful band, to minimize the effect of the aliasing, a GPS receiver uses an intermediate frequency which is as far as possible at the center of the useful band.

In the example of FIG. 5, the sampling frequency is equal to 16 MHz, hence it follows that the useful band lies between 0 to 8 MHz. 4 MHz is chosen as optimal intermediate frequency for the receiver in terms of interference reduction for the main lobe. FIG. 5 shows that on the useful band, the useful signal is higher than the aliased parts, this not being the case outside of this band. FIG. 5 also shows that the aliased lobes originating from each of the two replicas are as low as possible at the level of the main lobe.

On account of the harmful effects of the spectral overlap on the calculated correlation function, it is desirable to reduce this overlap.

Exemplary solutions for doing this will now be described.

Three solutions for reducing, or indeed eliminating, the influence of the spectral overlap associated with the sampling will be described. These solutions may be implemented independently of one another. Two of them, or indeed all, can as a variant be combined together.

According to a first example, the method comprises a step of filtering the analog signal S(t) received by the receiver 2, after this signal has been converted into low frequency FI by the receiver 2 and just before its sampling and its digitization.

During this step, use is made for example of a low-pass filter or an analog bandpass filter, of bandwidth less than or equal to 10 MHz, especially less than or equal to 8 MHz, especially less than or equal to 6 MHz, especially less than or equal to 4 MHz, especially less than or equal to 2 MHz.

This step makes it possible to limit the band of the spectrum of the signal to a lower value than that of the useful band, whose width equals half the sampling frequency.

In contradistinction to what was represented in FIG. 5, when the signal thus filtered is sampled, the aliased part of the spectrum is thereby greatly decreased since it is filtered beforehand. The elimination of the highest frequencies makes it possible to adopt the conditions of application of the Nyquist-Shannon theorem mentioned hereinabove.

In the case where the satellites 6 emit civilian GPS signals on L1, 90% of the energy of their spectrum is distributed over only 2 MHz.

The filter used during this step presents for example a passband of 2 MHz and the sampling frequency for the receiver 2 can lie between 4 and 5 MHz.

By virtue of the use of the filter, it is thus possible to limit the effect of the spectral overlap.

FIG. 6 is a table showing the effect of an analog anti-aliasing filter applied to the incident signal before sampling by the receiver, as has just been described.

To obtain the results appearing in this table:
a baseband signal (unmodulated, for which the frequency f_{L1} or FI is zero), is oversampled at a sampling frequency of 200 MHz. A first power ratio, designated by RPmax, is measured, this power ratio corresponding to the optimum that it is possible to hope to obtain by using an anti-aliasing filter under these conditions,
the oversampled signal is undersampled at a lower frequency. A second power ratio, smaller than the first, is obtained and which corresponds to a signal whose spectrum is aliased, in the absence of an anti-aliasing filter.

The difference between the first and the second power ratio corresponds to the maximum improvement that can be hoped for from the use of an anti-aliasing filter.

Thereafter, the simulations described hereinabove are performed again by adding a low-pass filter of Butterworth type of order 10 on the incident signal just before the undersampling operation. The first power ratio RPmax is then recovered, the values of which appear in FIG. 6, which conveys the effect of the anti-aliasing filtering on the signal.

FIG. 6 shows the improvements afforded to RPmax by virtue of the use of an anti-aliasing filter for a given sampling frequency. The first column of the table indicates the sampling frequency and the last column indicates the maximum improvement that can be obtained, given the oversampling frequency used. The label “n/a” indicates that a given filter width is not suitable since it exceeds half the sampling frequency concerned.

As may be seen in FIG. 6, whatever filter width is used, there is an appreciable improvement in the value of the correlation function. The positive effects of the anti-aliasing filtering outweigh the smoothing effect implied by the use of the anti-aliasing filter.

Another exemplary solution according to the invention for reducing the phenomenon of spectral overlap will now be described.

According to this example, the method comprises a step of oversampling. This technique of oversampling is especially known in computing in the 3D modeling of the objects in motion so as to remove the jaggedness which appears at the level of the contours, this is why it is called also “anti-abasing”.

According to this oversampling step, a sampling frequency is used which is considerably greater than that of the base spectrum of the signal, thereby making it possible to decrease the energy of the aliased part of the spectrum. By virtue of this oversampling step, the overlap noise is reduced. The Applicant has noted that the more the sampling frequency is increased, the more the secondary peaks of the correlation function tend to the single value of −1/1023, this resulting from the fact that a high sampling frequency decreases the portion of the energy of the spectrum which is abased.

FIG. 7 represents the maximum deviation in power between interfering signal and interfered signal Rpmax as a function of the sampling frequency during simulations carried out in the same manner as those described with reference to FIG. 6. The simulations, the results of which are represented in FIG. 7, are carried out in the absence of any anti-aliasing filtering step described hereinabove.

The results represented in FIG. 7 are moreover obtained with a receiver 2 having an intermediate or modulation frequency equal to a quarter of the sampling frequency. In the simulations performed, the sampling frequency values lie between 5 MHz and 100 MHz, so as to remain within technically “reasonable” values.

It may be noted that the oversampling makes it possible to push the maximum deviation in power between interfering signal and interfered signal Rpmax back to values which may be significant. Starting from a deviation value of 60 dB, attained for a sampling frequency of greater than 80 MHz, it may indeed be considered that the glare of the receiver is reduced in a very satisfactory manner.

It may also be noted that when the oversampling frequency is increased by a factor equal to 10, a gain of about 20 dB is obtained. Indeed, between Fe=10 MHz and Fe=100 MHz, the gain is 19.5 dB, and between Fe=5 MHz and Fe=50 MHz, the gain is 18 dB.

It is understood from FIG. 7 that the increase in the sampling frequency may afford, with respect to anti-aliasing filtering alone, a substantial gain in performance.

The invention is however not limited to the implementation of both an oversampling step and an anti-aliasing filtering step.

Nonetheless, the employment of a high sampling frequency during this oversampling step, for example when this frequency approaches 100 MHz, consumes energy. This is why another solution according to the invention for reducing the spectral aliasing is to implement a step of reducing the frequency of the code used.

The method implemented can comprise a step of reducing the frequency of the code modulating the signals emitted by the repealites 3. During such a step, preferably no action is taken on the carrier frequency of the signals emitted. It is possible to avoid modifying the analog part of the receiver 2, but act only on the digital part of the receiver 2.

After the frequency of the code has been reduced, the spectrum of the signal remains unlimited in band, but the energy is concentrated over a narrower band. Thus, it is possible to benefit from a spectrally denser signal which will be less prone to the interference of the spectral aliasing for the same sampling frequency.

It is for example possible to decrease the frequency of the code by as much as a factor of 20 when it is not desired to modify the frequency of the navigation message. In the case of a GPS signal, there will be 1 code per information bit instead of the 20 codes per bit of the conventional GPS signal.

If it is desired to go beyond this ratio 20, it is possible to decrease the frequency of the navigation message or to remove the navigation message.

Nonetheless, it is only possible to decrease the frequency of the code and, consequently, to increase its duration (therefore the duration of integration), up to a certain limit which must be compatible with the dynamics of the signal carrier.

It is known, for example from the publication KAPLAN Elliot & HEGARTY Christopher, “Understanding GPS Principles and Applications”, Artech House, 2006, 2nd Ed. Chapter 5, 730 p, that the duration of integration of the code must preferably be less than 600 ms.

Thus, it is possible, during this step, to reduce the frequency of the code by as much as a factor of 600.

A reduction in the frequency of the code by a factor of between 100 and 150 may turn out to be suitable according to the application considered.

With a receiver having a sampling frequency of 20 MHz, it is possible to attain performance equivalent to that which would be obtained for sampling frequencies of 2 to 3 GHz and a 1.023-MHz code.

Simulations carried out under the same conditions as those whose results were reported in FIG. 7, that is to say employing an anti-aliasing filter, show that for a sampling frequency of 20 MHz and a reduction in the frequency of the code by a factor of 100, a maximum deviation in power between interfering signal and interfered signal of 81 dB is obtained, thus corresponding to an appreciable reduction in the glare. This deviation goes to 95 dB for a sampling frequency of 100 MHz under the same conditions.

Furthermore, it is noted that reducing the frequency of the code modulating the signals causes an increase in the duration of a chip of the code. Now, this increase goes hand in hand with the increase in the “physical” performance region of a loop, not represented in FIG. 2, for reducing the short indirect paths, implemented software-wise by the receiver 2. This loop, also called SMICL is for example described in the publication JARDAK N., VERVISCH-PICOIS A., JEANNOT M., FLUERASU A., SAMAMA. N., “Optimised tracking loop for multipath mitigation Case of repeater based indoor positioning system”, ENC-GNSS 2008, April 2008, Toulouse, France.

For a code frequency of 1.023 MHz, the loop SMICL can reduce the paths down to 0.5 chips, this corresponding to 150 meters in the case of a GPS signal. If for example a code frequency reduced by a factor of 20 is used, the loop SMICL will reduce the effect of the indirect paths up to 150×20=3000 meters. Stated otherwise, the indirect paths which frustrate the SMICL must be larger than 3 km, this being a considerable advantage since few paths exceed such a distance when the system 1 is implemented inside.

Various simulation results will now be set forth with and without implementation of the method according to one of the examples described hereinabove.

Four emitters 3 which are repealites R1, R2, R3 and R4 are used to carry out these simulations. The repealite R1 has a signal whose power does not vary. The repealites R2, R3 and R4 have equal powers. The real time simulated equals 1 second. The sampling frequency is 50 MHz. The carrier/noise ratio of the receiver (C/N0) associated with the signal received originating from the repealite RI equals 50 dB-Hz.

For the simulations in dynamic mode, the Dopplers associated with each repealite equal respectively: 0 Hz for R1, −2.77 Hz for R2, −4.61 Hz for R3, −4.45 Hz for R4.

Without further detail, the receiver tracking loops are parametrized with an integration time of 1 Ms and the loop filters are of order I and have characteristic Bn=1 Hz for the filter 16 of the DLL loop 9 and Bn=10 Hz for the filter 21 of the PLL loop 8.

The power of the signals of R2, R3 and R4 is made to vary and the effect on the measurement of the pseudodistance between the receiver and R1 is observed, so as to reveal the effect of the method for reducing the glare described hereinabove.

Making several power levels vary while leaving an unchanged power level can correspond to the real case of a masking of the signal of an emitter by an obstacle.

Two simulations are conducted for each identical power level of R2, R3, R4 under the same conditions. The first simulation uses as code for each emitter of the system a shifted maximal length sequence. The second simulation is carried out using for each emitter the signal pair described hereinabove.

With a receiver 2 in dynamic mode, the Dopplers induced on each repealite 3 correspond to those of a receiver 2 travelling at 1 m/s along a small portion of circular trajectory 10 meters in diameter centered on a square 20 meters by 20 meters at whose four corners the repealites would be situated. The sequence chosen is that where the Doppler differences are the most varied with respect to one another. A portion of a circle is chosen for the displacement of the receiver 2 since this motion is convenient to simulate and fairly representative of real cases.

The real time simulated is one second, thus corresponding to 1000 measurements. These measurements are always taken from the moment the loops are locked-on, that is to say from the moment they have left the transient regime and are in the steady regime. Stated otherwise, the loops are locked-on when the local replicas of the incident signal, the carrier and the code, are in-phase with the incident signal. These replicas are then “slaved” to the incident signal.

It is chosen to simulate only an actual second of time for two reasons:
to limit the simulation time,
because the Dopplers do not vary enormously during a second.

The receiver's loop parameters such as they have been chosen by default are typical of those of tracking loops catering for the dynamics of a GPS signal.

Concerning the thermal noise, a fairly powerful base signal is used. A C/N0 of 50 dB-Hz remains, however, within the limits of reality for an indoor positioning system.

A sampling frequency equal to 50 MHz is chosen, so as to obtain a compromise between the execution speed of the simulator and the reduction in the effect of the spectral aliasing.

The simulation results have been obtained for power ratios between the repealite R1 and the other three repealites which go from 0 dB to 50 dB.

FIGS. 8 and 9 correspond to the case where the receiver 2 is static, FIG. 8 presenting the value of the error in the pseudodistance between the receiver and the repealite R1 as a function of the power ratio between the signal arising from R1 and the signals arising from the other repealites R1 for i≠1 and FIG. 9 giving the standard deviations obtained for these same errors. In FIGS. 8 and 9, the results obtained when the repealites each emit a pair of signals S1 and S2, as described previously, correspond to the curve 110 and the results when a single signal modulated by a maximal length sequence code is emitted by each repealite correspond to the curve 100.

It is noted in view of FIGS. 8 and 9 that onwards of a power ratio of between 20 and 30 dB, employing solely a maximal length sequence, the receiver 2 is dazzled by glare. As represented in FIG. 8, according to the curve 100 without emission by each emitter of the pair of signals S1 and S2, the error in the pseudodistance increases in an appreciable manner until in the example considered it attains a value of 1.3 meters when the power ratios are greater than 40 dB, the secondary inter-correlation peaks arising from the emitters other than the repealite R1 then being very significant relative to the main correlation peak.

As shown by the curve 110, the emission of a pair of signals S1 and S2 according to the invention makes it possible to prevent the secondary inter-correlation peaks from dominating the main correlation peak and the pseudodistance measurement is reliable. It is understood from FIG. 9 that the method according to the invention allows great stability in the error, even in the presence of significant glare.

Simulations with a higher sampling frequency, the results of which are not represented here, give a still more stable standard deviation for the method according to the invention, because the influence of the spectral aliasing is reduced, as explained hereinabove.

Thus, with a static receiver 2, the elimination of the interference is very satisfactory, or indeed total, as shown by FIGS. 8 and 9.

It will now be considered in the simulations performed that the receiver is dynamic, that is to say the relative Dopplers of the repealites are not zero.

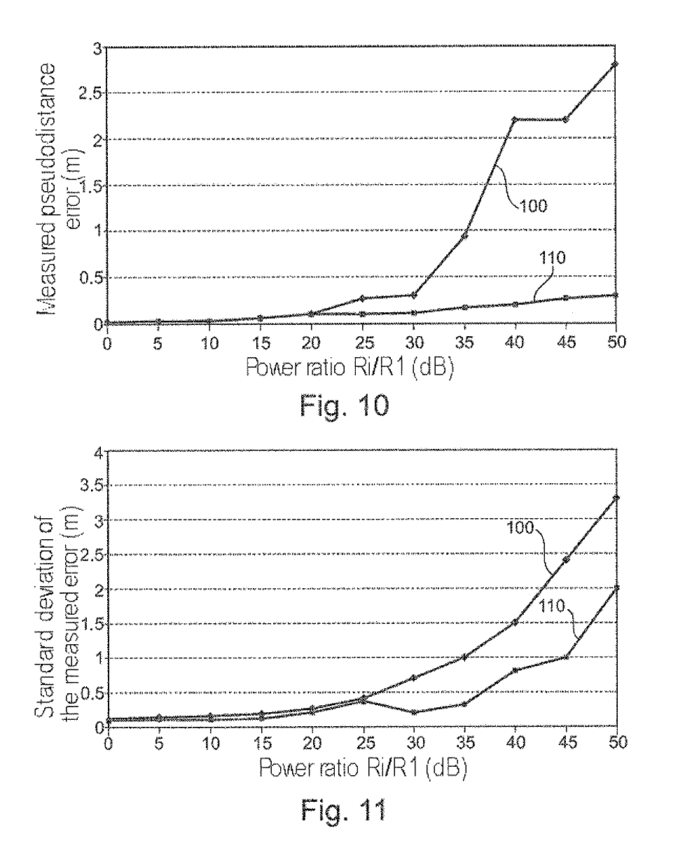

FIGS. 10 and 11 correspond to simulations similar to those of FIGS. 8 and 9 but differ therefrom through the fact that the Dopplers associated with each repealite equal respectively: 0 Hz for R1, −2.77 Hz for R2, −4.61 Hz for R3, −4.45 Hz for R4.

The comparison of curves 100 and 110 in FIGS. 10 and 11 shows that the method according to the invention makes it possible to reduce the error in the pseudodistance relative to the prior art.

To decrease the degradation caused in respect of the receiver 2 by the signals of the other emitters exhibiting a Doppler, it is possible to alter the filters 16 and 21 of the tracking loops, represented in FIG. 2, used by the receiver 2. These filters can make it possible to reduce the noise in the loop, but also the influence of the causes of “spurious” frequencies, namely the other emitters. When the invention is implemented inside, the expected dynamics is that of the inside of a building. It is then possible to use for the receiver 2 tracking loops with filters 16 and 21 having narrower bands and therefore to reduce the spurious oscillations.

By reducing the band of the filters 16 and 21 that are conventionally used by the GPS receiver, it is thus possible to reduce the disturbances due to the Dopplers of the emitters other than that whose signal it is sought to acquire and/or track. The band of these filters 16 and 21 is reduced for example by a factor for example equal to 2, or indeed 5, or indeed 10. The 1-Hz band of the filters 16 and 21 which is customarily used may be reduced to 0.5 Hz, or indeed to 0.1 Hz. The band of the filters 16 and 21 can even be reduced by a factor equal to 20 onwards of 1 Hz. As a variant, only the band of the filter 16 may be reduced by one of the factors mentioned hereinabove, the band of the filter 21 remaining equal to 1 Hz.

The invention is not limited to the examples which have just been described, and especially to the employment as code modulating the signals emitted by the emitters of a maximal length sequence.

It is for example possible to use instead a single Gold code generator by optimizing the choice of the emission lags between the repealites. It would also be possible as a variant to use other known codes for GPS such as a P (Precise or Protected) code.

For a receiver using a positioning system with n repealites and a single source signal, the signal S(t) received by the receiver 2 is a sum of n signals all having the same random pseudo code but delayed with respect to one another, as shown by equation (5.20) hereinbelow

$$S ( t ) = {\sum }_{i = 1}^{{n}_{s}} {\sum }_{k = 0}^{n - 1} {A}_{i , k} sin ( 2 π \cdot {f}_{L 1} \cdot t + {ϕ}_{i , k} ( t ) ) \cdot {d}_{i} ( t - {τ}_{0 , k} - {T}_{i , k} ) \cdot {c}_{i} ( t - {τ}_{0 , k} - {T}_{i , k} ) + n ( t ) \qquad ( 5.20 )$$

ns being the number of satellites 6 received by the outside antenna 7 and retransmitted by the repealites 3, n being the number of repealites 3 deployed for the inside positioning, Ai,k being amplitude of the signal of the satellite 6ᵢ retransmitted by the repealite 3ₖ, φi,k(t) being the phase of the carrier of the signal of the satellite 6ᵢ retransmitted by the repealite 3ₖ, the dependency in t indicating the presence of a Doppler, τ_{0,k}: lag induced on the signal between the repealite 3ₖ and the repealite 3₀ (the one which is not delayed) for k=0 . . . n−1, Ti,k being the delay equal to the sum of the propagation time outside of the signal of the satellite 6ᵢ, of the propagation time inside from the antenna of the repealite 3ₖ and of the clock bias of the receiver 2, di(t) being the navigation message for the satellite 6ᵢ, ci(t) being the pseudo-random code of the signal of the satellite 6ᵢ and n(t) taking into account the thermal noise and other sources of interference.

During the processing of the signal, the result of the correlation is in fact a sum of elements of the same auto-correlation function, but taken at various points. In order to reduce the glare-producing interference caused by the secondary peaks, it is possible to use the properties of the auto-correlation function of a Gold code. One of these properties is the existence of 3 secondary levels of peak and more particularly the smallest of them (1/1023) which is that of the auto-correlation function of a maximal sequence and which is also the most frequently encountered.

FIG. 12 shows the theoretical curve of the auto-correlation function of the Gold code of a GPS signal. It is centered on the main correlation peak.

FIG. 12, highlights the existence of “white regions” D where the correlation is minimal. The length of these regions is can vary greatly depending on the codes, but can be as much as several chips. It is then possible to choose the value of the lags τ_{0,k} between the repealites, the effect of this being to “displace” the auto-correlation peaks in the correlation pattern of the signal formed by the set of signals emitted by the repealites of the system 1. Stated otherwise, it is possible to translate the main correlation peaks of the incident signal, which are the useful parts of the correlation function, by altering the relative lags τ_{0,k} of the various emissions of the repealites. The basic idea is to choose the values of the lags τ_{0,k} in such a way that each main correlation peak corresponding to each repealite is translated into a white region common to all the other auto-correlation functions added together.

Thus, no secondary peak greater than −1/1023 will interfere with a main correlation peak of the incident signal received by the receiver 2. This will therefore yield performance in terms of reduction in interference which is entirely equivalent to that of a system using a maximal length sequence as code.

To arrive at a system equivalent to that which uses a maximal length sequence as code, three conditions are imposed on the values of the lags τ_{0,k} between the repealites:
there exists only a single optimization per code since each auto-correlation function is unique,
to be optimal, each main correlation peak is situated on the lowest level of all the other auto-correlation functions,
the lags τ_{0,k} are chosen in such a way as to comply with the 2 chips of width of the main correlation peaks plus the size of the environment, that is to say the size of the “white regions” D is at least 2 chips+dIndoor (dIndoor being defined as hereinabove).

A system equivalent to that which uses a maximal length sequence as code is obtained for example by proceeding as follows.

When the system comprises only two repealites emitting signals modulated by a Gold code, it is possible to choose the signals emitted by these repealites by using the property of symmetry with respect to the main peak of the auto-correlation functions of the Gold codes. Thus, if a white region of the auto-correlation function is sufficiently large and therefore appropriate to place one correlation peak, it will automatically be appropriate for the other correlation peak.

When the system comprises at least three repealites, it is desirable to ensure that the secondary peaks of the auto-correlation function of the repealite newly added to the previously considered system with two repealites will not interfere with the set of main peaks of the repealites previously utilized.

The white regions are relatively numerous so that optimization of the τ_{0,k} is possible for an acceptable number of repealites.

The algorithm mentioned in the publication VERVISCH-PICOIS A., SAMAMA N., “Interference mitigation in a repeater and pseudolite indoor positioning system”, IEEE Journal of selected topics in signal processing, vol 3 issue 5, pp 810-820, October 2009, is used for example to determine the maximum number of repealites that may be deployed for a given auto-correlation function.

The first step of this algorithm consists in searching for the white region closest to the main peak of the auto-correlation function of a repealite. Once the white region has been found, the second repealite is placed there, superimposing the two auto-correlation functions of the repealites, as in FIG. 13.

Once this first step has been performed, during a second step a search is made for the closest white region on the basis of the function resulting from the superposition of these auto-correlation functions.

This process is continued in an iterative manner with the succeeding repealites until there is no longer any white region, this being the algorithm's stopping condition.

The expression “comprising a” must be understood as synonymous with the expression “comprising at least one”, except when the converse is specified.

1. A method for reducing the glare of at least one receiver within a positioning system, the system comprising:
a plurality of emitters, each emitter emitting signals modulated by one and the same code whose auto-correlation function exhibits a main peak and at least one white region in which the auto-correlation function is a minimum, the signals comprising for each emitter a first signal modulated by the code and a second signal phase-shifted with respect to the first signal, the second signal being modulated by the code which is delayed with respect to the code modulating the first signal,
a receiver, the latter being configured to detect the signals emitted by the emitters and implementing, for a tracking of the first and of the second signals emitted by one of the emitters a local signal modulated by the code,
in which method:
each emitter emits the first, respectively signal, modulated by the code whose phase is different from the phases of the code modulating the first, respectively second, signal of the other emitters of the system, the main correlation peak of the first signal and that of the second signal emitted by each emitter being disposed in a white region of a calculated correlation function for a correlation between the local signal of the receiver and the signals emitted by all the other emitters of the system,
and,
a correlation function is calculated for the correlation between the local signal of the receiver and a signal resulting from a combination of the signals emitted by the emitters of the system.

2. The method as claimed in claim 1, wherein the code used is a maximal length sequence code.

3. The method as claimed in claim 1, wherein, for the emitters of the system, the phase shift of the code modulating the first, respectively second, signal are chosen beforehand from one emitter to the next, in such a way that the main correlation peak of the first signal and that of the second signal of each emitter are in a white region of the calculated correlation function for the correlation between the local signal and the signals emitted by all the other emitters of the system.

4. The method as claimed in claim 3, wherein the code phase shift between the code modulating the first signal emitted by one emitter and the code modulating the first signal emitted by another emitter is equal to the code phase shift between the code modulating the second signal emitted by said emitter and the code modulating the second signal emitted by the other emitter.

5. The method as claimed in claim 1, wherein the delay of the code modulating the second signal with respect to the code modulating the first signal is the same for at least two emitter of the system.

6. The method as claimed in claim 1, wherein the delay of the code modulating the second signal with respect to the code modulating the first signal is different for at least two emitters of the system.

7. The method as claimed in claim 1, wherein the phase shift between the first and the second signal emitted by each emitter is equal to 180° to within 10%.

8. The method as claimed in claim 1, being implemented inside (indoors).

9. The method as claimed in claim 1, the receiver performing an anti-aliasing filtering of the signals emitted by the emitters with the aid of a filter of bandwidth less than or equal to 10 MHz.

10. The method as claimed in claim 1, the receiver performing a sampling of the signals emitted by the emitters according to a sampling frequency such that a ratio between the sampling frequency and a width of a base spectrum of the emitted signals is greater than 2.

11. The method as claimed in claim 10, wherein the emitters emit a GPS signal of frequency L1 and in which the sampling frequency lies between 5 MHz and 100 MHz.

12. The method as claimed in claim 1, wherein the receiver decreases a frequency of the code modulating the signals emitted by the emitters by a ratio of greater than 20.

13. A positioning system, comprising:
a plurality of emitters, each emitter emitting signals modulated by one and the same code whose auto-correlation function exhibits a main peak and at least one white region in which the auto-correlation function is a minimum, the signal comprising for each emitter a first signal modulated by the code and a second signal phase-shifted with respect to the first signal, the first, respectively second, signal being modulated by the code which is delayed with respect to the code modulating the first, respectively second, signal of the other emitters of the system, the main correlation peak of the first signal and that of the second signal emitted by each emitter being disposed in a white region of a calculated correlation function for the correlation between the local signal of the receiver and the signals emitted by all the other emitters of the system,
and
a receiver configured to receive the signals emitted by the emitters and implementing, for a tracking of the first and of the second signal emitted by one of the emitters, a local signal modulated by the code, the receiver being configured to calculate a correlation function for the correlation between the local signal of the receiver and a signal resulting from a combination of the signals emitted by the emitters of the system.

14. An emitter of the positioning system such as defined in claim 13, the system comprising at least one other emitter and a receiver configured to detect the signals emitted by the emitter and the other emitter, the emitter being configured to emit a signal modulated by a code common to the other emitter of the system and a second signal phase-shifted with respect to the first signal, the second signal being modulated by the code which is delayed with respect to the code modulating the first signal.

15. A receiver of the positioning system such as defined in claim 13, the system comprising a plurality of emitters each emitting signals modulated by one and the same code whose auto-correlation function exhibits a main peak and at least one white region in which said auto-correlation function is a minimum, the signals comprising for each emitter a first signal modulated by the code and a second signal phase-shifted with respect to the first signal, the second signal being modulated by the code which is delayed with respect to the code modulating the first signal,
the receiver being configured to receive the signals emitted by the emitter and implementing, for the tracking of the first and of the second signal emitted by one of the emitters, a local signal modulated by the code, and to calculate a correlation function for the correlation between the local signal of the receiver and a signal resulting from a combination of the signals emitted by the emitters of the system.
